(19) United States
(12) Patent Application Publication
(10) Pub. No.: US 2021/0140156 A1
(43) Pub. Date: May 13, 2021

(54) DOMESTIC WATER TAP WITH A SAFETY DEVICE

(71) Applicant: Greg Rowe Limited, Norwich (GB)

(72) Inventor: Gregory Norman ROWE, Norwich (GB)

(73) Assignee: Greg Rowe Limited, Norwich (GB)

(21) Appl. No.: 16/976,610

(22) PCT Filed: Mar. 1, 2019
(86) PCT No.: PCT/GB2019/050585

§ 371 Date: Aug. 28, 2020

(30) Foreign Application Priority Data
Mar. 2, 2018 (GB) 1803404.1

(51) Int. Cl. E03C 1/04

(52) U.S. Cl. CPC E03C 1/0411; F16K 19/006; E03C 1/0412; E03C 1/0404

(57) ABSTRACT

The present techniques relate to a safety device (10) for a tap, particularly a domestic water tap or faucet. The tap has an operating mechanism (46) which is activated by a user to dispense boiling or near boiling water. The safety device (10) comprises at least one grip member (12) for a user to hold when placing the safety device (10) on a tap. The safety device (10) further comprises a housing (14). The housing (14) comprises at least one side wall. When the safety device (10) is mounted on a tap having an operating mechanism, the side wall at least partially surrounds and projects beyond the operating mechanism in a direction which is aligned with a direction of movement of the operating mechanism.

### FIELD

The present invention relates to a safety device for a tap, particularly a domestic water tap or faucet.

### BACKGROUND

Various types of taps are known, including single lever or dual lever taps which deliver a mixture of hot and cold water from mains sources as well as dual lever taps which deliver water from a plurality of sources, including mains sources, filtered water sources, near boiling or boiling water sources or carbonated water sources.

Taps which dispense near boiling or boiling water typically include safety mechanisms to prevent inadvertent discharge of the water. For example as described in EP2990703 to the present applicant, a user must keep the handle in position to maintain the flow of water through the valve. GB2542627 describes a detachable safety clip which can be fitted to a tap to prevent operation of the tap. In both these examples, the tap comprises a lever mechanism for operation of the tap. However, there are alternative mechanisms for operating taps are known and thus the applicant has recognised the need for alternative safety mechanisms.

### SUMMARY

According to the invention, there is provided a safety device for a tap and a tap as defined in the independent claims. Further features of the invention are described in the dependent claims.

We describe a safety device for a tap having an operating mechanism which is activated by a user to dispense boiling or near boiling water from the tap by movement in an axial direction, the safety device comprising at least one grip member for a user to hold when placing the safety device on a tap and a housing comprising at least one side wall, which when the safety device is mounted on a tap having an operating mechanism, at least partially surrounds and projects beyond the operating mechanism in a direction which is aligned with a direction of movement of the operating mechanism. By projecting beyond, the at least one side wall effectively blocks access to the operating mechanism to prevent inadvertent activation.

Boiling water may be defined as water at or around 100 degrees Celsius and near boiling water as water between 95 to 100 degrees Celsius. Inadvertent or accidental dispensing of such water poses a risk to users. The operating mechanism itself may provide a primary or main mechanism for preventing accidental dispensing of hot or boiling water. This is because the operating mechanism must be activated by the user to dispense boiling or hot water. When the safety device is mounted on the tap, the operating mechanism is blocked by the side wall and/or a cover as described below so a user cannot access and activate the operating mechanism to dispense boiling or near boiling water. A user must remove the safety device to activate the operating mechanism which provides another level of safety for a user in addition to the operating mechanism itself.

In use, the housing may grip the operating mechanism to removably attach the safety device to the tap. The at least one side wall may define a chamber which grips the operating mechanism. The chamber may be configured to have a suitable size and shape to match the size and shape of the operating mechanism. The housing may further comprise a cover covering the chamber. In use, when the detachable safety device is mounted to the tap, the operating mechanism may be housed within the chamber and covered by the cover. In this way, the cover together with the at least one side wall prevent inadvertent activation of the operating mechanism.

There may be a pair of side walls which define a first open end, e.g. to the chamber, through which the operating mechanism is inserted into the chamber and an opposed second end. The first end may be larger than the second end. The distance between the pair of side walls, in other words the size or width of the chamber, may taper gradually, i.e. linearly, between the first and second ends. The tapering may allow the operating mechanism to be easily inserted into the chamber through the open end and may allow the housing, particularly the side walls, to securely grip the operating mechanism to help prevent inadvertent removal of the safety device. The second end may be closed to prevent access to the operating mechanism.

The grip member may further form a mounting means for mounting the safety device to the tap. The grip member may comprise a base from which at least one wall extends. When the safety device is mounted on the tap, the at least one wall may grip an outer surface of the tap, e.g. the outer surface of the tap handle, particularly a handle boss, to secure the safety device to the tap. The housing may be integral with the at least one wall. The at least one side wall of the housing may project generally perpendicularly to the at least one wall of the grip member.

The grip member may comprise a plurality of walls, e.g. two or more. Additional walls may provide increased grip on the tap or may provide an increased contact surface for a user to hold the device to remove the device from the tap or place it on the tap. The walls may be equally spaced around the base. The base may be shaped to connect each wall of the grip member together to form a robust, easy to use device. There may be a gap between each adjacent pair of walls. The use of one or more gaps may help adapt the safety device to be compatible with different types of taps, for example by ensuring that the device does not interfere with components of the tap. For example, a gap may be configured to receive a component, such as a tapered protrusion, of a rotation mechanism which enables a user to rotate the tap handle to dispense water. The use of one or more gaps may also facilitate removal of the safety device from the tap. For example, if the wall of the grip member extends continuously around an outer surface of the tap, when a user grips the wall to remove the safety device, this could squeeze the wall so that it is a tighter grip on the tap. Thus, such an arrangement may be more difficult for a user to remove.

The grip member may releasably mount the safety device to the tap by having a shape which is a snug or interference fit on the tap, particularly on an end of the tap, e.g. the tap boss. For example, the base may match the shape of the end face of the tap and may be generally planar and/or circular. Similarly, the at least one side wall may extend generally perpendicular to the base and/or may be curved to match the cylindrical shape of the tap. For a circular base, the at least one wall may extend around a circumference of the base and may thus be a circumferential wall.

Typically, the operating mechanism is machined to a better tolerance than the tap boss. Accordingly, securing the safety device to the tap may be more reliable when the housing is designed to grip the operating mechanism than when the wall of the grip member is designed to grip to the tap handle. Both the housing and the wall of the grip member may be used together to mount the security device to the tap.

In addition to the extra security provided by the housing, the safety device may comprise a visual indicator, for example a warning triangle and temperature. It will be appreciated that other locations and types of visual indicator may be used. The visual indicator may be on an external, i.e. visible, face of the base.

The safety device may be manufactured from any suitable material which allows the safety device to be easily positioned on the tap, for example a material which is lightweight, softer than the material of the tap itself and has a degree of flexibility. The safety device may be made from a thermally resistant material to reduce any heat transfer. Examples of suitable materials include thermoplastics. Other suitable materials will be apparent to the skilled person, for example aluminium could be used.

We also describe a safety device for a tap having an operating mechanism which is activated by a user to dispense boiling or near boiling water from the tap, the safety device comprising a base; a grip member for a user to hold when placing the safety device on a tap, the grip member comprising a first wall and a second wall extending from the base and a housing on the first wall, the housing comprising at least one side wall which extends generally perpendicular to the first wall. When the safety device is mounted on tap having an operating mechanism, the at least one side wall at least partially surrounds and projects beyond the operating mechanism in a direction which is aligned with a direction of movement of the operating mechanism

In use, the safety device may be mounted on a tap. Thus we also describe a tap for dispensing boiling or near boiling water, the tap comprising an operating mechanism which is activated by a user to dispense the boiling or near boiling water, and the safety device as described above; wherein the safety device is mounted to the tap and the operating mechanism is at least partially surrounded by the at least one side wall.

The operating mechanism may be a button mechanism comprising a button which must be depressed by a user. Once the button is depressed, the user is able to rotate the handle to dispense water. The rotation of the handle to dispense water may be considered a separate or second operating mechanism and the button mechanism may be considered to be a primary or safety operating mechanism. The at least one side wall may extend beyond the button mechanism in a direction which is parallel to or axially aligned with a direction of movement of the button mechanism when depressed by a user.

### BRIEF DESCRIPTION OF DRAWINGS

Further features and advantages of the invention will become apparent from the following description of preferred embodiments of the invention, given by way of example only, which is made with reference to the accompanying drawings.

FIG. 1a is a front perspective view of a safety device according to a first example;

FIG. 1b is a rear perspective view of the safety device of FIG. 1a;

FIG. 1c is a cross-sectional view of the safety device of FIG. 1a;

FIGS. 2a and 2b are exploded isometric views of the safety device of FIG. 1a in use on two examples of taps;

FIG. 2c is a variant of the safety device shown in FIG. 2a;

FIG. 3a shows a cross-sectional view of part of the tap of FIG. 2b;

FIG. 3b is an exploded isometric view showing various components in a system incorporating the tap of FIG. 2b.

### DESCRIPTION OF EMBODIMENTS

FIGS. 1a to 1c show a safety device 10 comprising a grip member 12 which may be held by a user to releasably mount the safety device to a tap as described below. The safety device further comprises a housing 14 which in use covers an operating mechanism for a tap as described below and thus the safety device may be termed a safety cover. In the arrangement shown, the grip member 12 comprises a base 16 from which first and second walls (or flanges) 18, 20 extend. Gaps are defined between the walls 18, 20 so that as explained below the safety device does not interfere with components on the tap and the safety device can be easily removed from the tap. It will be appreciated that a different number of walls may be used.

The housing 14 is integral with and generally centrally located on the first upper wall 18 and comprises a pair of side walls 28 between a first open end 24 which receives the operating mechanism and a second end 26. The side walls and ends define a chamber 22. As shown more clearly, in FIGS. 1a and 1c, in this example the chamber 22 gradually tapers in size from the first open end 24 to the second closed end 26 so that the operating mechanism can be easily received into the larger open end 24 but once the safety device is mounted on the tap body, the operating mechanism may be gripped by the side walls. The housing also comprises a cover 30 which covers the chamber and hence, in use, the operation mechanism. The second end 26 may be closed to prevent access to the operating mechanism.

FIGS. 2a and 2b show how the safety device 10, 100 is fitted onto two different tap handles 40, 60 both of which are generally cylindrical in shape with flat, circular end faces 42, 62. FIG. 2c is a variation of the safety device of FIG. 2a and thus the same numbers have been used for the tap in both drawings.

For each tap, a rotation mechanism is provided on each tap body to allow a user to rotate the tap handle to activate the tap. The tap handle can be turned in one direction (e.g. clockwise) to obtain boiling water and in the other direction to obtain cold water. The tap may be provided with visual indicators 68, e.g. as shown in FIG. 2b, to indicate the appropriate direction of rotation for each type of water. The tap handle 40, 60 also comprises an operating mechanism in the form of a button 46, 66. The button 46, 66 must be depressed by the user to enable the tap handle 40, 60 to be rotated to dispense boiling water. The inclusion of the button mechanism thus prevents boiling water being inadvertently dispensed by simple rotation and thus the operating mechanism may be termed a safety operating mechanism. The button does not need to be depressed by the user to enable the tap handle 40, 60 to be rotated to dispense cold water and thus cold water can be dispensed when the safety device is mounted on the tap. Thus, in this arrangement, the safety device does not prevent rotation of the tap when the safety operating mechanism does not need to be activated.

In each arrangement, the grip member is shaped to be a snug or interference fit on the tap handle so that the safety device can be securely but releasably mounted onto a tap handle. Thus the grip member also may be termed a mounting means. Accordingly, in these examples, the base is generally planar and circular to match the shape of the end face of the two example tap handles. In this way, the safety device can be mounted onto either tap handle so that it sits flush with the end face of the tap handle and thus the overall size of the tap is only increased slightly. Similarly, the walls 18, 20 and 118, 120 extend generally perpendicular to the base and are curved to match the cylindrical shape of the tap handle.

The safety device may also be adapted for use to be compatible with or not to interfere with different components of the tap. For example, in FIGS. 2a and 2c, the tap handle 40 comprises a rotation mechanism comprising a pair of tapered protrusions 44 on opposed sides of the tap handle 40. The protrusions 44 are axially mounted on the tap handle 40 and in use, a user pushes against the protrusions 44 to turn the tap handle 40. In FIG. 2b, the tap handle 60 comprises a rotation mechanism comprising a plurality of projections arranged in a band around the end of the handle 60. As shown in FIGS. 2a and 2c, the walls 18, 20 and 118, 120 are equally spaced around the base and are separated by two gaps which each receive one of the tapered protrusions 44. In this way, the safety device does not interfere with other components of the tap and a user is still able to operate the tap to dispense water which is not boiling by pushing on the protrusions to rotate the tap. The same shape of safety device also fits onto the tap of FIG. 2b but it will be appreciated that the gaps are not necessary to avoid any features of the tap itself. However, the gaps may also assist in removing the safety device from the tap. For example, if the walls were replaced by a continuous wall, gripping the continuous wall to remove the safety device could tighten the grip of the safety device on the tap thus making it harder to remove. The gaps reduce this effect.

More generally, a skilled person would appreciate that if the tap handles have a different design, either in terms of shape or operating mechanism, to those shown in FIG. 2a or 2b, the shape of the safety device could be adapted to match the tap handle. For example, using non-circular designs or different shaped housings as appropriate. A skilled person would also appreciate that the base needs to connect the walls of the grip member to each other but need not be planar or circular to do so.

As shown in FIGS. 2a and 2b, the safety device 10 may be pushed onto the tap handle so that the button is received in and covered by the housing 14. The safety device and in particular the housing 14 thus prevents a user from inadvertently pushing the button and accidentally dispensing scalding water. The safety device may be pulled off by a user to access the button, for example, the user may grip one or both walls to remove the safety device.

As shown in FIG. 2c, the safety device 100 may be pushed onto the tap handle so that the button is received in but unlike in the previous arrangement is not covered by the housing 114. There is no cover on the housing 114. The housing comprises a pair of side walls 128 which project above the height of the button once the safety device 100 is mounted on the tap. It will be appreciated that the side walls of the housing in FIGS. 2a and 2b must also project above the height of the button for the button to be housed therein. The pair of side walls 128 project generally perpendicular to the upper wall 180 of the grip member.

In addition to the extra security provided by the housing, the safety device may comprise a visual indicator 70 which alerts the user that the tap is not a normal tap and dispenses boiling water. In this example, the visual indicator 70 is a warning triangle and temperature shown on the opposed side of the base to the side from which the flanges extend. It will be appreciated that other locations and types of visual indicator may be used.

The safety device may be manufactured from any suitable material which allows the safety device to be easily positioned on the tap. The safety device may be made from a thermally resistant material to reduce any heat transfer. Examples of suitable materials include thermoplastics or aluminium.

The tap shown in FIG. 2a may incorporate an internal return spring mechanism so that once a user releases the handle, the handle returns to its starting position. Such a return spring mechanism is described for example in GB2542627 and WO2017/042586. Both of these publications describe a lever mechanism which requires two movements; first compress the end of the lever downwards against an axial return spring and whilst maintaining the compression force, rotate the lever against a circumferential return spring. Once the compression force is released, the lever automatically returns to its starting position. It will be appreciated that the compression of the lever is similar to the depression of a button mechanism and thus, it will be immediately apparent how to incorporate the return mechanism into the tap of FIG. 2a. A similar mechanism is also shown, for example, in FIGS. 10 and 14 of GB2531142 to the present applicant.

By contrast, the tap shown in FIG. 2b may not incorporate a circumferential spring mechanism. In such a tap, it will be necessary to manually return the tap to the off position. It will be appreciated that the inclusion of a circumferential spring mechanism may increase the force required to turn the handle. The turning of the handle in FIG. 2a may thus be facilitated by the presence of the tapered fin shaped protrusions 44. The diameter of the handle may also be larger than that of FIG. 2b.

Referring to FIGS. 3a and 3b, there is illustrated an example of a system incorporating a water tap 1000 which is a so-called “4 in 1 boiling water tap”. The tap 1000 comprises an outer body piece 1010 which is cross-shaped in cross-section. The tap 1000 further comprises a cylindrical spout 1016. Water preferably routes through an inner body which is housed within the tap so that the outer body piece 1010 does not come into contact with any water flowing through the tap.

The outer body piece 1010 houses the valves needed to dispense water. For example, as shown in FIG. 3a, there is a valve 1020 which is a filtered water and boiling water selector valve which allows a user to select filtered water or boiling water but not a mixture of filtered and boiling water. The second valve may be a mains hot and cold water mixer valve which allows a user to mix hot and cold water in any combination. The tap 1000 further comprises a button operating mechanism 1014 operatively connected to the first valve 1020 and a lever operating mechanism 1015 operatively connected to the second valve

Depressing the button causes compression of the spring 1013 and a pin which is inserted into the button is disengaged from a vertical stop. This allows a user to turn the handle which controls the valve 1020 to cause water from the boiling water source to flow through the tap 1000 and be dispensed through an inner outlet within the spout 1016. Once the user no longer wishes to dispense boiling water, the tap is returned to the starting position. The button is also released which allows the pin to re-engage the vertical stop to prevent further unintended dispensing of boiling water. The pin may also be incorporated in the tap with a spring return mechanism. The tap may be arranged so that a user can turn the handle in the opposite direction, without depressing the button, to dispense cold filtered water. By activating the second handle, a user can control the valve 1020 to cause water from hot and cold water sources to flow through the tap 1000 and be dispensed through an outer outlet within the spout 1016. Such handles, their mechanism and the manner in which they control valves such as the valves are known for example from WO2017/042586 and EP2990703 to the present applicant. The information contained in these publications is herein incorporated by reference.

As shown in FIG. 3b, four hoses 1040a, 1040b, 1040c, 1040d are provided to supply water from water sources to the inner body 100 in the tap 1000. In this example, a first hose 1040a connects the tap to a mains hot water source, a second hose 1040b connects the tap to a mains cold water source, a third hose 1040c connects the tap to a filtered water source 1070 and a fourth hose 1040 connects the tap to a boiling filtered water source 1080. The hoses may comprise a rubber (or similar flexible material) in a braided stainless steel outer (or similar more robust protective housing). Alternatively, the hoses may comprise a copper pipe onto which the connector is soldered.

The boiling water source is in the form of a boiler which has a compact design that can be easily fitted into a standard kitchen cabinet. The compact design may hold over 4 litres. The boiler is connected to a water supply and a power source. The boiler is insulated and efficient so that it uses very little power to keep the water at around 100° C. (and above 98° C.). For example, the boiler may consume less than 1 watt of electricity per hour in standby mode. The boiler operates at a minimum pressure of 1.5 bar for hot and cold supply and up to a maximum pressure of 5 bar.

It will be appreciated that the safety device may be used with any tap having a button or similar mechanism which can be at least partially enclosed by part of the safety device. Thus, although a tap having two handles is detailed above as an example of an application for the safety device, a skilled person will readily understand that the safety device may also be used on single handle taps. For example, the tap may only have a single valve which dispenses boiling water and the safety device may be used with such a tap.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A safety device for a tap having an operating mechanism which is activated by a user to dispense boiling or near boiling water from the tap, the safety device comprising
a grip member for a user to hold when placing the safety device on a tap and
a housing comprising at least one side wall, which when the safety device is mounted on tap having an operating mechanism, at least partially surrounds and projects beyond the operating mechanism in a direction which is aligned with a direction of movement of the operating mechanism.

2. The safety device of claim 1, wherein the at least one side wall defines a chamber comprising a first open end through which the operating mechanism is inserted into the chamber and an opposed second end which is smaller than the first end.

3. The safety device of claim 2, wherein a width of the chamber tapers gradually between the first and second ends.

4. The safety device of claim 1, wherein the grip member comprises a base from which at least one wall extends.

5. The safety device of claim 4, wherein the housing is integral with the at least one wall.

6. The safety device of claim 4, wherein the grip member comprises a plurality of walls with a gap between each adjacent pair of walls.

7. The safety device of claim 4, wherein the base is substantially planar.

8. The safety device of claim 7, wherein the at least one wall extends substantially at right angles to the base.

9. The safety device of claim 4, wherein the at least one wall is curved.

10. The safety device of claim 1, further comprising a visual indicator to indicate that the tap dispenses near boiling or boiling water.

11. The safety device of claim 1, wherein the safety device is made from a thermoplastics material.

12. The safety device of claim 1, wherein the grip member is configured to be an interference fit on a tap.

13. A safety device for a tap having an operating mechanism which is activated by a user to dispense boiling or near boiling water from the tap, the safety device comprising
a base;
a grip member for a user to hold when placing the safety device on a tap, the grip member comprising a first wall and a second wall extending from the base and
a housing on the first wall, the housing comprising at least one side wall which extends generally perpendicular to the first wall.

14. A tap system for dispensing boiling or near boiling water, the tap system comprising
a tap having an operating mechanism which is activated by a user to dispense the boiling or near boiling water, and
the safety device as claimed in claim 1;
wherein when the safety device is releasably mounted to the tap, the operating mechanism is housed within the housing.

15. The tap system of claim 14, wherein the operating mechanism is a button mechanism.

16. The tap system of claim 14, wherein the housing comprises a pair of side walls and wherein when the safety device is releasably mounted to the tap, the operating mechanism is gripped by the pair of side walls.

17. The tap system of claim 14, wherein the grip member is configured to be an interference fit on a tap.

18. The tap system of claim 14, wherein the at least one side wall defines a chamber comprising a first open end through which the operating mechanism is inserted into the chamber and an opposed second end which is smaller than the first end.

19. The safety device of claim 13, wherein the housing comprises a pair of side walls and wherein when the safety device is releasably mounted to the tap, the operating mechanism is gripped by the pair of side walls.

20. The safety device of claim 13, wherein the grip member is configured to be an interference fit on a tap.
